(19) United States
(12) Patent Application Publication
(10) Pub. No.: US 2026/0222735 A1
(43) Pub. Date: Jul. 30, 2026

(54) ADJUSTING SPEAKER OUTPUT IN GAMING DEVICES

(71) Applicant: Sony Interactive Entertainment Inc., Tokyo (JP)

(72) Inventors: Calum Armstrong, London (GB); Christopher George Buchanan, London (GB); Michael Lee Jones, London (GB)

(21) Appl. No.: 19/447,227

(22) Filed: Jan. 13, 2026

(30) Foreign Application Priority Data
Jan. 28, 2025 (GB) 2501213.9

(51) Int. Cl. H04R 3/04; A63F 13/54; A63F 13/92; H04R 1/02; H04R 1/40; H04R 3/12; H04R 29/00

(52) U.S. Cl. CPC H04R 3/04; A63F 13/54; H04R 1/028; H04R 1/403; H04R 3/12; H04R 29/002; A63F 13/92; H04R 2201/401; H04R 2430/01; H04R 2499/11; H04R 2499/15

(57) ABSTRACT

A gaming device comprising a speaker configured to receive an audio signal and output an audio output; a detector configured to detect whether the speaker is at least partially obstructed; and a processor configured to initiate one or more alleviating actions in response to a detection that the speaker is at least partially obstructed.

### CROSS REFERENCE TO RELATED APPLICATIONS

This application claims priority to UK Application No. 2501213.9, filed on Jan. 28, 2025, the contents of which are incorporated herein by reference.

### FIELD OF THE INVENTION

The present invention relates to a system and method for adjusting speaker output in portable gaming devices.

### BACKGROUND

Portable gaming devices, such as handheld devices, are designed for portability and ease of use, allowing gamers to enjoy immersive experiences wherever they go. These devices often come with built-in speakers to deliver high-quality sound without the need for external audio equipment. However, a common issue with such devices is that users frequently cover the speakers with part of their hands during gameplay, either partially or fully. This unintentional obstruction results in a degraded audio experience and could also lead to long-term damage to the speakers due to changes in internal pressure within the device's casing.

The present disclosure aims to address these issues.

### SUMMARY

According to an aspect of the invention there is provided a gaming device comprising a speaker configured to receive an audio signal and output an audio output, a detector configured to detect whether the speaker is at least partially obstructed, and a processor configured to initiate one or more alleviating actions to adjust the audio output from the speaker in response to a detection that the speaker is at least partially obstructed.

By using a detector to detect speaker obstructions and implementing adaptive audio responses, the gaming device ensures that users consistently experience high-quality sound, regardless of how the gaming device is being held. This not only enhances the gaming experience but also protects the hardware from potential damage due to pressure buildup in obstructed speakers.

Preferably, the detector is located within a housing of the gaming device, in close proximity to the speaker. In this context, close proximity refers to a distance that allows the detector to directly and effectively monitor conditions affecting the speaker caused by obstruction. This could be within a few millimetres to a few centimetres from the speaker, depending on the detector type. Locating the detector within the housing of the gaming device, in close proximity to the speaker, helps ensure accurate monitoring and timely detection of any obstruction or interference with the speaker, and timely action in response to any obstruction.

In some examples, the detector is located within a speaker grille within the housing.

The detector may comprise at least one pressure sensor. In this case, the pressure sensor may preferably be located within a few millimetres of the speaker grille, preferably integrated directly into the speaker grille or surrounding area. Since pressure sensors need to detect even slight changes in pressure, being very close to the speaker ensures they can respond immediately to the presence of a user's hand covering the area.

The detector may comprise at least one light sensor. The light sensor may be located within 1-2 centimetres of the speaker grille. Light sensors monitor changes in ambient light to detect when the speaker is covered and so being slightly offset from the speaker allows them to monitor light conditions in the immediate vicinity and detect obstructions quickly.

The detector may comprise at least one temperature sensor. The temperature sensor may be located within 2-5 millimetres of the speaker. These sensors measure heat changes caused by the user's hand in contact with the speaker area and so the sensor needs to be close enough to detect temperature differences but can work effectively even when slightly removed from direct contact.

The detector may comprise at least one sound sensor. The sound sensor may be located within 0.5-2 centimetres of the speaker grille, preferably integrated around or within speaker grille. These sensors detect changes in sound waves (such as echoes or muffling) when the speaker is obstructed and so being located close to the speaker ensures they can capture real-time acoustic variations that indicate obstruction.

The one or more alleviating actions may comprise at least temporarily stopping driving the obstructed speaker. This may help prevent damage to the speaker caused by pressure building up as a result of the obstruction.

In some examples, the one or more alleviating actions comprises modifying the audio signal intended for the obstructed speaker to generate a modified audio signal. The modifying the audio signal may comprise equalizing one or more frequencies in the audio signal. The modifying the audio signal may comprise boosting one or more frequencies in the audio signal. Modifying the audio signal for an obstructed speaker helps improve the overall audio experience and maintain the functionality of the gaming device even when a speaker is partially or fully covered by the user's hand or another object.

In some examples, the one or more alleviating actions comprises re-directing at least part of the audio signal intended for the obstructed speaker to one or more other speakers located on the gaming device. Preferably, the re-directing comprises re-directing all of the audio signal intended for the obstructed speaker to one or more other speakers located on the gaming device. In this way, none of the audio output is lost as a result of the obstructed speaker and the user still experiences a complete audio output.

In some examples, the one or more alleviating actions comprises performing intelligent sound mapping to re-direct one or more components of the audio signal from the obstructed speaker to one or more other speakers of the gaming device. Preferably the one or more components being re-directed are components that are considered important for game play, such as dialogue. In some examples, components that are not considered important for gameplay are not re-directed. By redirecting specific components of the audio signal to unobstructed speakers in real time, the system maintains a balanced, high-quality listening experience. Additionally, it protects the speakers from damage while allowing users to interact with the device naturally, without interruption to gameplay.

The speaker may be one of a plurality of speakers forming a speaker grid. The speakers are preferably evenly distributed across the gaming device. In some examples, the speaker grid covering substantially the entire surface of the gaming device. In other examples, the speaker grid covers one or more regions of the gaming device e.g. side regions. Providing multiple speakers on the gaming device may help ensure there is a continuous audio output even if one or more speakers becomes obstructed during play.

There gaming device may comprise a plurality of detectors. Each detector may be associated with one or more speakers. In some examples there may be more speakers than detectors. In some examples there may be the same number of speakers as detectors such that there is a one-to-one correspondence between speakers and detectors. In this way, each detector may be configured to detect obstruction of one or more speakers within the vicinity of the detector. Providing each speaker with a corresponding detector ensures accurate and timely detection of an obstruction. Each detector in the plurality of detectors may be the same type of detector, or different types of detectors may be combined. The use of different types of detectors with multiple speakers helps ensure timely detecting of an obstruction so that effective alleviative action can be taken.

In some examples, the audio output from the speaker grid is dynamically adjusted based on where a speaker obstruction is detected. Dynamically adjusting the audio output from the speaker grid based on the location of the obstruction helps ensure that the gaming device maintains high audio performance even when a speaker is partially covered.

According to another aspect there is provided a method of adjusting audio output from a speaker of a gaming device comprises the steps of receiving, by a processor, an indication from a detector that a speaker is at least partially obstructed, and initiating, by the processor, one or one or more alleviating actions to adjust the audio output from the speaker.

### BRIEF DESCRIPTION OF DRAWINGS

Embodiments of the present disclosure will be described by way of example only with reference to the accompanying drawings in which:

FIG. 1 shows an exemplary portable gaming device;

FIG. 2 shows another exemplary gaming device;

FIG. 3 shows another exemplary gaming device; and

FIG. 4 shows a method of adjusting the speaker output.

### DETAILED DESCRIPTION

In handheld gaming systems, speakers are often placed near the edges of the device, where users naturally grip the device during use. This ergonomic placement leads to scenarios where the user's thumb or other parts of the hand at least partially cover the speaker.

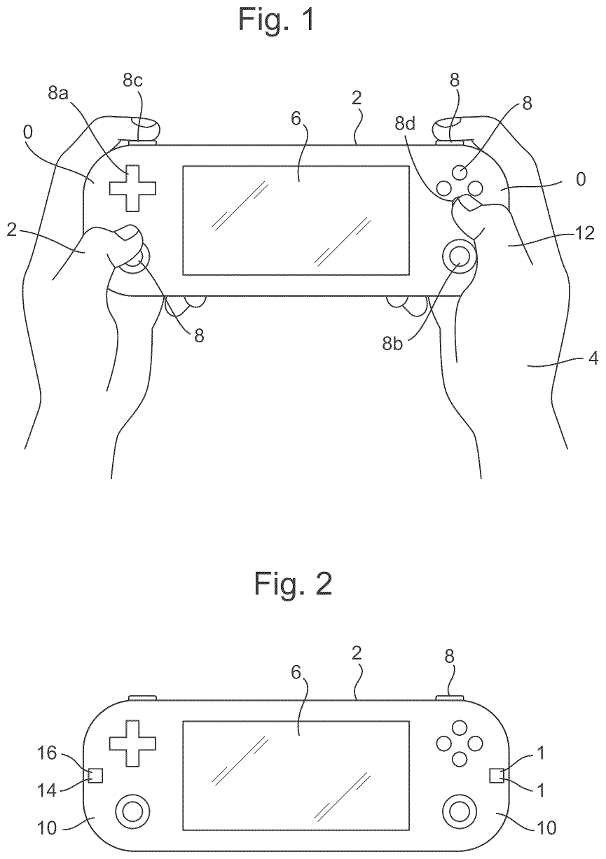

FIG. 1 shows an exemplary portable gaming device 2 designed to be held by a user 4. The gaming device 2 comprises a display screen 6 for displaying gameplay, a plurality of input controls 8, including directional pads 8a, thumb sticks 8b, shoulder controls 8c, and buttons 8d. The gaming device 2 comprises at least one speaker 10, two are illustrated in FIG. 1, near the side edges of the gaming device 2. The speaker 10 receives an audio signal and outputs an audio output. As can be seen in FIG. 1, the user's thumbs 12 at least partially cover the speakers 10 on either side of the gaming device 2 when accessing one or more of the input controls 8. Several issues arise from this.

Firstly, when a speaker is covered, it can muffle the sound, reducing clarity and volume. This degraded sound quality reduces the overall listening experience. Secondly, covering the speaker creates an enclosed chamber, increasing internal pressure that could cause damage to the speaker over time. Additionally, covered speakers result in a poor audio representation of the game's sound design. This suboptimal audio feedback to the user contributes towards reduced user satisfaction during gameplay.

In order to address this issue, the gaming device 2 comprises a detector 14 as shown in FIG. 2. The detector 14 is configured to detect when a speaker 10 is at least partially obstructed by at least part of the user's hand (e.g. thumbs 12) or other objects. Upon detection of an obstruction, the gaming device 2 initiates one or more alleviating actions in response, in order to improve the audio experience and/or protect the speakers 10.

The detector 14 comprises at least one sensor 16 which is able to determine when a speaker 10 is obstructed. Once obstruction is detected, processors within the gaming device 2 system can dynamically adjust the audio output to mitigate the effects of the obstruction.

The gaming device 2 can employ several different types of sensors 16, individually or in combination with each other, to detect when a speaker 10 is covered. The one or more sensors are located within a housing of the gaming device 2 in an area that is in close proximity to the speaker 10 or on the speaker grille itself. This ensures that any obstruction can be detected quickly and accurately.

In some examples, the sensor 16 is a pressure sensor. The pressure sensor detects when a force is applied to the area of the housing comprising the speaker 10 indicating that the speaker 10 is being at least partially covered by the user.

A light sensor can be used alternatively or additionally. The light sensor detects when ambient light levels suddenly drop, indicating an obstruction. For example, when part of a user's hand covers part of the speaker 10, it will also block light from reaching the light sensor, providing a clear signal for detection.

Alternatively or in addition, a temperature sensor can be used to detect an increase in temperature caused by the user contacting the housing in the speaker area. A rapid increase in temperature, for example, a spike in temperature may indicate that the speaker is being covered. However, it should be noted that a spike in temperature is not necessary, provided the temperature has increased from an ambient temperature of the housing.

As another example, alternatively or in addition to the sensors mentioned above, a sound sensor may be used. For example, a micro-electro-mechanical system (MEMS) microphone or other acoustic sensors can be used to detect changes in the sound waves emitted by the speaker. For example, if the sound reflects or echoes unusually it can be determined that there is an obstruction at least partially covering the speaker 10.

Once an obstruction is detected, one or more processors execute one or more of the following responses to alleviate the effects of the speaker obstruction.

As a first option, the processors may stop, either temporarily or for the duration of the gaming session, driving the speaker 10 which is obstructed. In this example, the processor stops the audio signal to the obstructed speaker 10 to prevent sound distortion and protect the speaker 10 from potential damage. This may have the effect of stopping all audio output from the gaming device 2 if there is only one speaker 10 and that speaker 10 is obstructed, or it may simply cause the obstructed speaker 10 to become at least temporarily inactive in but other unobstructed speakers 10 remain unaffected. This method can be useful if the speaker 10 is substantially fully obstructed such that the resulting audio output is too poor quality.

Another response action taken when an obstruction is detected includes the processors performing some sort of audio compensation for the obstructed speaker 10. For example, in situations where the speaker 10 is only partially, rather than fully, obstructed the processors may continue to drive the speaker 10 but modify the audio output, to correct for the effect of the obstruction on the audio output. Such a modification, or adjustment, could involve equalizing frequencies to minimize distortion or boosting specific audio frequencies that better penetrate the obstruction. This creates a new sonic profile that compensates for the muffling effect of the user's hand or other obstructions.

If the gaming device comprises more than one speaker 10, the processors can reroute and redirect the audio signal intended for the obstructed speaker 10 to the other available speakers 10. This may involve duplicating the audio signal meant for the obstructed speaker 10 or redistributing the audio signal between multiple other speakers 10 in a way that maintains the stereo or surround sound experience originally intended in the absence of the obstruction. Thus, in some situations, the entire sound profile is transferred to any remaining speakers 10, allowing the system to maintain the audio quality and overall experience, despite the obstruction.

Selective redistribution of the audio signal could also be implemented, as part of the one or more alleviating actions performed by the processor. In this case, the processors could perform intelligent sound mapping, where only certain elements of the audio signal, such as dialogue or environmental sounds, are moved to a different speaker 10 while other elements that may be considered less important to the current game play, like background music, continue to play from the obstructed speaker 10.

Any of the above-mentioned alleviating actions may be combined with each other or used individually.

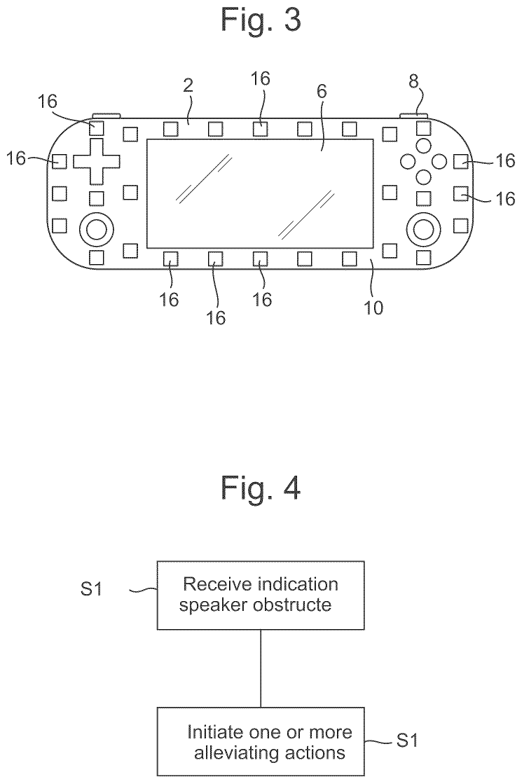

FIG. 3 shows another embodiment of a gaming device 2. In this example, substantially the entire surface of the gaming device 2 acts as dynamic speakers. For example, the entire housing of the gaming device 2 could be equipped with flat-panel speakers or other distributed speaker technologies. A speaker grid is formed withing the housing of the gaming device. The speakers making up the speaker grid could work in conjunction with a sensor system comprising a plurality of sensors distributed around the housing that detect where the user is holding the device.

For example, capacitive or resistive touch sensors could detect where the user is holding the device, determining areas of the housing that are being covered. Based on the detected holding areas, the processors of the gaming device 2 could dynamically adjust the audio output of the speaker grid. For example, if the user covers a lower left corner of the housing of the gaming device 2, the processors could reduce or disable audio output from that region and could also enhance audio output from uncovered areas.

It should be noted that instead of the entire surface of the gaming device 2 being converted into speaker grid, multiple key sections of the gaming device may act as dynamic speakers, for example the entire side regions of the gaming device (rather than just localised regions near the edges).

By converting the entire surface or key sections of the gaming device into speakers 10, users may experience a more immersive soundscape which may help to enhance gameplay. In addition, the processors system could adapt the audio output based on how the user is holding the device, optimizing the sound profile for different grip styles. Furthermore, since sound can emanate from various regions of the gaming device, the issue of a single obstructed speaker becomes less problematic, as the sound can be adjusted to flow from uncovered areas.

The skilled person will appreciate that one or more of the ideas describe above may be combined with each other.

FIG. 4 shows a method of adjusting audio output from a speaker 10 of a gaming device 2 comprising the steps of receiving S100 an indication from a detector 14 that a speaker 10 is at least partially obstructed, and initiating S102 one or one or more alleviating actions to adjust the audio output from the speaker 10. The method may be carried out by one or more processors within the gaming device 2.

As can be seen, the above-described gaming device addresses problems of reduced audio quality when speakers are obstructed by a user during gameplay. In particular, the gaming device uses various sensors to detect when the speaker is obstructed and automatically applies corrective actions. These actions include redistributing the sound to other speakers, modifying the audio profile, or temporarily muting the covered speaker to avoid distortion. Additionally, in some examples, the entire device or specific areas of the device act as dynamic speakers that adapt to how the device is held and adjust the audio output accordingly.

1. A gaming device comprising:
a speaker configured to receive an audio signal and output an audio output;
a detector configured to detect whether the speaker is at least partially obstructed; and
a processor configured to initiate one or more alleviating actions to adjust the audio output from the speaker in response to a detection that the speaker is at least partially obstructed.

2. The gaming device of claim 1, wherein the detector is located within a housing of the gaming device, in close proximity to the speaker.

3. The gaming device of claim 1, wherein the detector is located within a speaker grille.

4. The gaming device of claim 1, wherein the detector comprises a pressure sensor.

5. The gaming device of claim 1, wherein the detector comprises a light sensor.

6. The gaming device of claim 1, wherein the detector comprises a temperature sensor.

7. The gaming device of claim 1, wherein the detector comprises a sound sensor.

8. The gaming device of claim 1, wherein the one or more alleviating actions comprises at least temporarily stopping driving the obstructed speaker.

9. The gaming device of claim 1, wherein the one or more alleviating actions comprises modifying the audio signal intended for the obstructed speaker to generate a modified audio signal.

10. The gaming device of claim 9, wherein modifying the audio signal comprises equalizing one or more frequencies in the audio signal.

11. The gaming device of claim 9, wherein modifying the audio signal comprises boosting one or more frequencies in the audio signal.

12. The gaming device of claim 1, wherein the one or more alleviating actions comprises re-directing at least part of the audio signal intended for the obstructed speaker to one or more other speakers located on the gaming device.

13. The gaming device of claim 12, wherein the re-directing comprises re-directing all of the audio signal intended for the obstructed speaker to one or more other speakers located on the gaming device.

14. The gaming device of claim 1, wherein the one or more alleviating actions comprises performing intelligent sound mapping to re-direct one or more components of the audio signal considered important for game play away from the obstructed speaker and to one or more other speakers located on the gaming device.

15. The gaming device of claim 1, wherein the speaker is one of a plurality of speakers forming a speaker grid, wherein the speaker grid covers substantially the entire surface of the gaming device.

16. The gaming device of claim 15 wherein each speaker in the plurality of speakers is associated with a corresponding detector.

17. The gaming device of claim 15, wherein the audio output from the speaker grid is dynamically adjusted based on where a speaker obstruction is detected.

18. A method of adjusting audio output from a speaker of a gaming device, the method comprising:
receiving, by a processor, an indication from a detector that a speaker is at least partially obstructed; and
initiating, by the processor, one or one or more alleviating actions to adjust the audio output from the speaker.

19. The method of claim 18, wherein the one or more alleviating actions are selected from the group consisting of: at least temporarily stopping driving the obstructed speaker, modifying the audio signal intended for the obstructed speaker to generate a modified audio signal, re-directing at least part of the audio signal intended for the obstructed speaker to one or more other speakers located on the gaming device, and performing intelligent sound mapping to re-direct one or more components of the audio signal considered important for game play away from the obstructed speaker and to one or more other speakers located on the gaming device.

20. The method of claim 18, wherein the audio output from the speaker grid is adjusted dynamically based on where a speaker obstruction is detected.
